(19) United States
(12) Patent Application Publication
(10) Pub. No.: US 2026/0084331 A1
(43) Pub. Date: Mar. 26, 2026

(54) HYBRID BLANKING FRAME, BLANKING SYSTEM, AND SHEET PROCESSING MACHINE

(71) Applicant: BOBST MEX SA, Mex (CH)

(72) Inventors: Alexandre VOLERY, Fey (CH); Dominique NICOLO, Chernex (CH)

(73) Assignee: BOBST MEX SA, Mex (CH)

(21) Appl. No.: 19/110,982

(22) PCT Filed: Sep. 14, 2023
(86) PCT No.: PCT/EP2023/075300

§ 371 Date: Mar. 12, 2025

(30) Foreign Application Priority Data
Sep. 15, 2022 (EP) 22195946.3

(51) Int. Cl. B26D 7/18; B26D 7/26; B26F 1/44

(52) U.S. Cl. CPC B26D 7/1818; B26D 7/2614; B26F 1/44; B26D 2007/2607

(57) ABSTRACT

The present invention generally relates to a hybrid blanking frame for a sheet processing machine, a blanking system, and a sheet processing machine. The hybrid blanking frame comprises a circumferential frame enclosing an interior space. A movable bar is mounted between opposite side frame portions of the circumferential frame. The hybrid blanking frame is configured to support a full-sheet-delivery setup, a guillotine setup, and a quick-lock blanking setup.

### FIELD OF THE DISCLOSURE

The present invention generally relates to a hybrid blanking frame for a sheet processing machine, a blanking system, and a sheet processing machine, in particular in a full sheet and blanking processing machine.

### BACKGROUND

In sheet processing machines sheets are processed in manifold fashions. For example, a sheet may be stamped, cut or die cut so as to establish a number of desired blanks from the sheet. As a consequence of the stamping and or die cutting procedure, the sheet comprises blank portions and waste portions. In a stripping station usually the waste is at least partially ejected. In the following blanking station the sheets are received and/or at least partially separated and/or the waste surrounding the blanks to keep them together as a sheet is partially or completely removed. Then the blanks or sheets are collected and prepared for further processing while waste portions are removed from the machine. During the blanking process for the separation procedure specialized support surfaces might be applied providing through-holes which may be used for the separation procedure. In view of different shapes of the blanks, the support surfaces need to be interchangeable for tailoring the respective patterns such from the separation of the blanks may be reliably achieved.

Another processing technique concerns a guillotine device configured for separating a tailored portion of the sheets, usually the front portion at which the sheet is transported by the gripper bar, of a pile of sheets along at least one side frame of the pile. In this regard, a support surface needs to be provided such that all sheets of the pile of sheets are treated by the guillotine device in a similar manner. For example, all sheets need to be aligned with regard to each other.

Furthermore, in some cases it is rather desired that full sheets may be provided to a particular machine station and, subsequently, further delivered to additional downstream machine stations.

For this reason, in known sheet processing machines different respective frames are used distinguishing from each other for providing respective support structures in view of the described different processing techniques, namely, a first frame having a full-sheet-delivery setup, a different second frame having a guillotine setup, and a different third frame having a quick-lock blanking setup.

Since various different frames are required, the complexity of sheet processing machine is high as one frame is used at a time only. The remaining frames have to be stored separately thereby increasing the total space required. Moreover, as different frames are needed, the production expenses are high. For example, since three specialized frames have to be separately produced, the return of investment is slow. In addition, the off time of the sheet processing machine is long-lasting since for different purposes the frames have to be interchanged with regard to each other. As those frames need to be caried in and out of the machine platform, this creates possible human safety hazards

Accordingly, there is a need for a frame, a blanking system, and a sheet processing machine such that the disadvantages according to the prior art can be avoided or at least reduced. Advantageously, the off time of a processing machine having the frame may be shortened thereby improving the overall production efficiency of the machine. Also, it is desired, to improve practicability of the frame and the processing machine while production expenses are lowered.

### SUMMARY

The subject matter of the independent claims satisfy the respective need. Preferred embodiments are indicated within the dependent claims and the following description, each of which, individually or in combination, may represent aspects of the disclosure.

A summary of certain embodiments disclosed herein is set forth below. It should be understood that these aspects are presented merely to provide a brief summary of these certain embodiments and that these aspects are not intended to limit the scope of this disclosure. This disclosure may encompass a variety of aspects that may not be set forth below.

According to an aspect, a hybrid blanking frame for a sheet processing machine is provided. The hybrid blanking frame comprises a circumferential frame enclosing an interior space. A movable bar is mounted between opposite side frame portions of the circumferential frame. The hybrid blanking frame is configured to support a full-sheet-delivery setup, a guillotine setup, and a quick-lock blanking setup.

The full-sheet-delivery setup comprises a combined first mounting mechanism for mounting a detachable front bar at the front frame portion, a detachable rear bar at the movable bar, and detachable side guides parallel to the side frame portions to receive sheets in the interior space delimited by the detachable side guides, rear bar and front bar.

The guillotine setup comprises the front frame portion configured to receive a template bar and at least the template bar and the movable bar establish a support surface to receive sheets.

For the quick-lock blanking setup at least the front frame portion of the circumferential frame and the movable bar establish a support for a blanking grid plate and wherein the quick-lock setup comprises plate guide pins extending at least from the front frame portion and the movable bar.

Accordingly, a single hybrid blanking frame is provided which may be used for all of the before mentioned different purposes. Spoken differently, the single hybrid blanking frame is multifunctional in the sense that all required frame related purposes may be served with only one single frame. Consequently, production costs are lowered since no set of three individual frames is required anymore. In addition, storage space is saved since there are no non-used frames anymore. Also, time savings are provided such that the off time of a sheet processing machine having the frame is reduced thereby improving the overall production efficiency. Further, there is no need to change the entire frame for the different purposes.

These advantages are achieved as the hybrid blanking frame comprises a circumferential frame which is configured such that the overall frame may be prepared for all different purposes. Namely, for a full-sheet-delivery setup and for a guillotine setup additional components (extension components) may be mounted while plate guide pins for a quick-lock blanking setup are mounted or might stay or even be fixed if they do not interfere with the additional components. Accordingly, if the additional components are removed the plate guide pins may be used to appropriately attach a blanking grid plate.

In essence, the different setups are provided while the complexity of the frame is rather low. Therefore, the manageability of the frame is high. Moreover, the single hybrid blanking frame provides the possibility to standardize sheet processing machines with regard to the frame as no different frames for different purposes have to be considered anymore. Thus, the sheet processing machine may be specifically adapted to the design of the hybrid blanking frame. In addition, only little training is needed in order for non-trained persons to securely operate the frame. For the full-sheet-delivery setup the front bar, the rear bar, and the side guides delimit a respective area according to the dimensions of the sheet which is to be received by the setup.

The template bar may be considered a component specifying a particular shape according to which one or more sheets are treated by a guillotine device. This means that the template bar defines a shape according to a portion of the one or more sheets wherein the portion is separated from a remainder of the respective sheets by the guillotine device, usually a part of the waste is still attached to the blanks, this could be the part which is engaged with a gripper bar of the sheet processing machine for transporting the sheets. That is, the guillotine device may be considered a component configured for edge trimming of one or more sheets such that a portion specified by the template bar is separated from the remainder of the respective sheet and the waste part which is engaged with the gripper bar is released.

The blanking grid plate may be considered a support structure configured for separating blanks of a sheet. That means that during a stamping procedure or the like several blanks may be prepared in a sheet. In between the blanks remaining portions of the sheet represent waste portions which are usually removed in the stripping station and then the blanks are required to be separated. This happens mainly in the stripping station. In the blanking station blanks are separated and/or residual waste for the transport of the sheets eliminated or the sheets are just delivered as such. The blanking grid plate provides a support surface for arranging the sheet thereon. The blanking grid plate may comprise one or more through-holes such that the blanks may be guided through the through-holes thereby separating the different species from each other. Usually, the blanking grid plate may comprise a wooden material or may be fabricated from metal. However, since different blanks comprise usually different shapes, such as blanks for different packages, the through-hole pattern provided by the blanking grid plate needs to be adapted as well. Accordingly, in view of different blanks usually different blanking grid plates are applied. Therefore, fast exchangeability of the blanking grid plate is preferred since the operating efficiency of the sheet processing machine is improved thereby. Thus, a quick-lock blanking setup provides for the ability to mount a blanking grid plate in a simple but reliable fashion while a time period required for interchanging different blanking grid plates with regard to each other is short using the present hybrid blanking frame.

According to a preferred embodiment of the invention the detachable side guides are configured to engage with or be mounted at mounting arms extending from the front frame portion. In another embodiment the detachable side guides might be configured to engage with the side frame portions. Optionally the front frame bar might comprise a screw lock pattern configured to receive a template bar in a guillotine setup.

Preferably, for the quick-lock blanking setup the front bar, the rear bar, and the side guides of the full-sheet-delivery setup are detached. That means that the complexity of the hybrid blanking frame for the quick-lock blanking setup is particularly low. No specific extension components are required for guaranteeing the quick-lock blanking setup. In case these bars and guides do not interfere with the quick-lock blanking setup, they can be partially or completely stay attached during a quick-loch blanking setup.

Optionally, a first distance between the side guides is adaptable by a first linear drive. Accordingly, the hybrid blanking frame is adaptable in view of the sheet dimensions along a first axis. Thus, the application range is improved.

Preferably, a second distance between the front frame portion and the movable bar is adaptable by a second linear drive. Therefore, the hybrid blanking frame is adaptable to different sheet dimensions along a second axis. The second axis is oriented perpendicular to the first axis. Hence, the hybrid blanking frame provides an even enlarged scope of application.

In some embodiments, the first axis may correspond to a width of a sheet while the second axis may correspond to a length of a sheet. Therefore, the first axis corresponds to a width of the interior space enclosed by the circumferential frame while the second axis corresponds to a length thereof.

Optionally, each linear drive may be configured such that a distance which is adaptable by means of the respective linear drive may be varied continuously. That is, the respective linear drive is not restricted to discrete positions but may provide a continuous travel way. Accordingly, desired dimensions of the hybrid blanking frame in view of a length and/or a width thereof may be adjusted at high precision. Preferably, each linear drive comprises safety clutch. For example, the safety clutch may comprise a locking wheel for blocking the respective linear drive. To be able to operate a linear drive, an operating person may be required to unlock the locking wheel and keep the locking wheel in the unlocking position. Therefore, unwanted movement of a linear drive may be prevented.

In some embodiments, the quick-lock blanking setup also comprises at least one centering pin for centering the blanking grid plate. Accordingly, an appropriate orientation of the blanking grid plate with respect to the hybrid blanking frame may be guaranteed by the centering pin in a simple fashion.

Optionally, the front frame portion comprises a front slot and the movable bar comprises a rear slot. The front slot and the rear slot may be configured to receive clamps of the blanking grid plate. While the orientation of the blanking grid plate may be guaranteed by respective pins of the quick-lock blanking setup, the clamps may assist in holding the blanking grid plate. Therefore, the blanking grid plate may resist external forces to a higher extent. Such external forces may for example be applied onto the blanking grid plate during the separation procedure of the blanks. Preferably, the hybrid blanking frame comprises an interface for a sheet supporting device. The interface may be automatically activated if the front bar is mounted. Within sheet processing machines sheets are usually moved using supporting devices, such as gripper bars. For opening a gripper bar such that a carried sheet is relieved thereof, an interaction with an opening device is required. In this regard, the interface be configured to open the gripper bar. In particular, the interface is arranged such that, as a consequence of the interaction with the gripper bar, the relieved sheet is appropriately arranged in view of its orientation on the hybrid blanking frame or the support surface thereof.

In some embodiments, the combined first mounting mechanism comprises bar guide pins extending into the interior space of the frame for supporting at least one of the front bar, the rear bar, and the side guides. Consequently, mounting the front bar, the rear bar, and the side guards may be simplified since the bar guide pins guarantee an appropriate alignment of the respective components.

Optionally, the combined first mounting mechanism comprises magnetic connections for supporting at least one of the front bar, the rear bar, and the side guides. Thus, mounting one of these components may be achieved with a reduced number of screws since the magnetic connections already provide a stable mounting connection, at least to some extent. Also, by reducing the number of needed screwed connections, the time period required for mounting these connections is reduced. Therefore, the operating efficiency of a sheet processing device having the hybrid blanking frame is improved.

Preferably, the combined first mounting mechanism comprises releasable compression fittings for mounting the side guides to the mounting arms. Releasable compression fittings allow side guides to be mounted in a quick fashion. In other words, in view of the side guides screwed connections may be avoided. Accordingly, time savings are provided as to the specific mounting mechanism of the side guides.

In some embodiments, support blocks and/or support stops are mountable at the detachable front bar and the detachable rear bar for the full-sheet delivery setup and the guillotine setup. Using the support blocks and/or the support stops, the support surface may be better defined for these setups. Therefore, an appropriate alignment of the at least one sheet is guaranteed.

Optionally, the frame comprises a lock for locking the frame to a sheet processing machine. A movable indicator indicating a present setup of the frame is configured to cover the lock. Therefore, unwanted detachment of the hybrid blanking frame from the sheet processing machine is avoided since it requires to unlock the lock. Moreover, by covering the lock using a movable indicator, firstly, the present setup is directly and unambiguously indicated for operating persons, and, secondly, an additional safety mechanism is established which needs to be undertaken prior to detaching the frame from the sheet processing machine. Unwanted interference with the sheet processing machine may therefore be avoided at an improved safety level.

According to another aspect, a blanking system is provided. The blanking system comprises a hybrid blanking frame as described hereinbefore. Moreover, the blanking system comprises a blanking grid plate mounted to the hybrid blanking frame. This means that the hybrid blanking frame is prepared according to the quick-lock blanking setup and that the respective blanking grid plate is attached thereto.

According to even a further aspect, a sheet processing machine is provided which comprises a hybrid blanking frame as described hereinbefore or a blanking system as described hereinbefore.

All features and embodiments disclosed with respect to any aspect of the present disclosure are combinable alone or in (sub-)combination with any one of the remaining aspects of the present disclosure including each of the preferred embodiments thereof, provided the resulting combination of features is reasonable to a person skilled in the art.

### DESCRIPTION OF THE DRAWINGS

The forgoing aspects and further advantages of the claimed subject matter will become more readily appreciated as the same become better understood by reference to the following detailed description when taken in conjunction with the accompanying drawings. In the drawings,

FIG. 1 is a schematic drawing of a sheet processing machine according to an embodiment of the invention,

FIG. 2 is a schematic drawing of a hybrid blanking frame according to the full-sheet-delivery setup according to an embodiment of the invention,

FIG. 3 is a schematic drawing of a front frame portion of the hybrid blanking frame according to an embodiment of the invention,

FIG. 4 is a schematic drawing of magnetic connections provided by the hybrid blanking frame according to an embodiment of the invention,

FIG. 5 is a schematic drawing of a side guide used with the full-sheet-delivery setup,

FIG. 6 is a schematic drawing of a first linear drive of the hybrid blanking frame according to an embodiment of the invention,

FIG. 7 is a schematic drawing of a second linear drive of the hybrid blanking frame according to an embodiment of the invention,

FIG. 8 is a schematic drawing of a safety clutch of the second linear drive,

FIG. 9 is a schematic drawing of a support block mounted to the hybrid blanking frame according to an embodiment of the invention,

FIG. 10 is a schematic drawing of a lock and a movable indicator of the hybrid blanking frame according to an embodiment of the invention,

FIG. 11 is a schematic drawing of a hybrid blanking frame according to the quick-lock blanking setup according to an embodiment of the invention,

FIG. 12 is a schematic drawing of a front frame portion of the hybrid blanking frame according to an embodiment of the invention,

FIG. 13 is a schematic drawing of a blanking system according to an embodiment of the invention,

FIG. 14 is a schematic drawing of a front frame portion of the hybrid blanking frame according to an embodiment of the invention, and

FIG. 15 is a schematic drawing of a hybrid blanking frame according to the guillotine setup according to an embodiment of the invention and a template bar.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

All of the features disclosed hereinafter with respect to the example embodiments and/or the accompanying figures can alone or in any sub-combination be combined with features of the aspects of the present disclosure including features of preferred embodiments thereof, provided the resulting feature combination is reasonable to a person skilled in the art.

FIG. 1 is a schematic drawing of a sheet processing machine 10 according to an embodiment of the invention.

The sheet processing machine 10 comprises an introduction station 12, a platen press station 14, a waste ejection station 16, a blanking station 18, and an ejection station 20. At the introduction station 12, a pile of sheets 22 is provided. The sheets 22 are then transferred using a chain drive 24 having gripper bars 26 through the sheet processing machine 10.

At the platen press station 14, the sheets 22 are treated such that blanks are prepared within each sheet 22. In some embodiments also die cutting devices, creasing devices or the like may be used in this regard.

At the subsequent waste ejection station 16, sheets 22 are arranged and tools are applied to eject waste parts in particular between the blanks. Nevertheless, usually the sheets are kept together for example by nick points and/or frame waste parts, also to further transport the sheet to the blanking station 18.

The sheets 22 are then transferred to the blanking station 18 and usually arranged on a frame and according to the shown embodiment on a hybrid blanking frame 28. According the shown embodiment the hybrid blanking frame 28 is used with a specific setup, such as the full-sheet-delivery setup, the guillotine setup, or the quick-lock blanking setup. For example, according to the quick-lock blanking setup of the hybrid blanking frame 28. At the downstream ejection station 20, the pile of blanks 34 or sheets can be removed through an output 36 from the sheet processing machine 10.

The hybrid blanking frame 28 according to the present invention is multifunctional and may be used within the blanking station 18 according to different purposes.

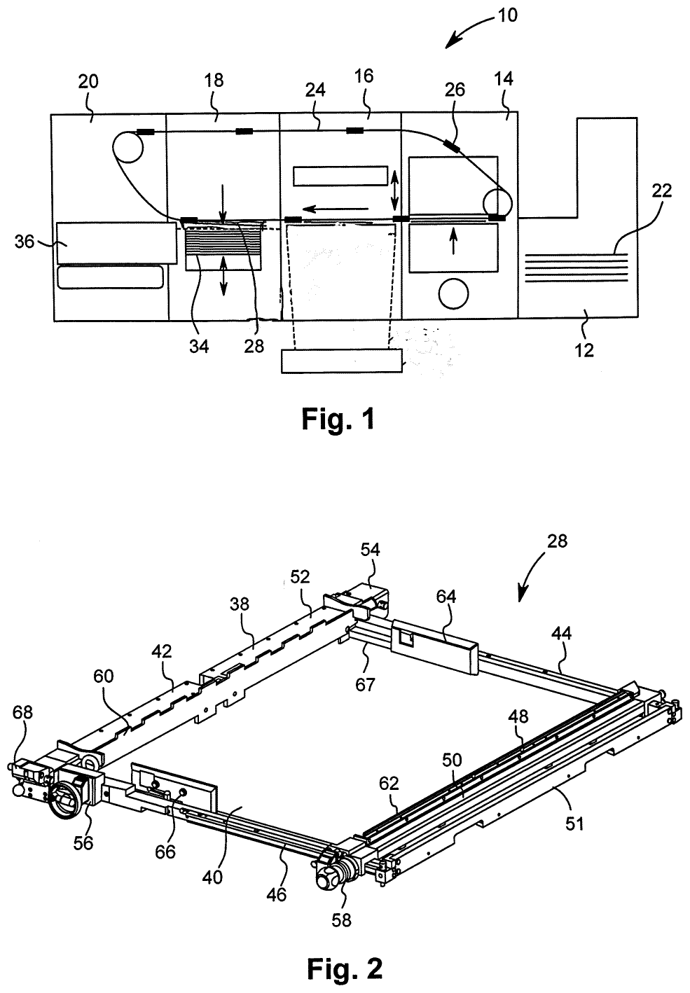

FIG. 2 is a schematic drawing of a hybrid blanking frame 28 according to the full-sheet-delivery setup according to an embodiment of the invention.

The hybrid blanking frame 28 comprises a circumferential frame 38 enclosing an interior space 40. Generally, the sheets 22 are arranged within the interior space 40 or within a space vertically aligned therewith.

The circumferential frame 38 comprises according to the shown embodiment a front frame portion 42, a first side frame portion 44, a second side frame portion 46, and a rear wall portion 48 at least partially enclosing the interior space 40. The rear wall portion 48 according to the shown example is provided by a movable bar 50 which is mounted between the opposite side frame portions 44, 46. Generally, the circumferential frame 38 comprises a rectangular shape. The side frame portions 44, 46 extend from the front frame portion 42 to an end wall portion 51 of the circumferential frame 38. The front frame portion 42 and the end wall portion 51 extend between the opposite side frame portions 44, 46. The movable bar 50 is oriented in parallel to the end wall portion 51.

Depending on the setup of the blanking frame a support surface 52 is might be established at least partially by the front frame portion 42 and the rear frame portion 48. The support surface 52 may also be established by additional components, such as the side frame portions 44, 46. Generally a part of the support surface 52 extends in two directions being oriented perpendicular to each other. While the hybrid blanking frame 28 is usually positioned within the sheet processing machine 10 such that the circumferential frame extends in a horizontal plane, a surface normal of the support surface 52 is oriented perpendicular thereto and, thus, is oriented according to a vertical direction. In a full sheet setup the according elements might not establish a horizontal support, but rather define a space to take up the sheets.

The hybrid blanking frame 28 comprises an interface 54 for interacting with the gripper bars 26 of the chain drive 24. Due to the interaction between the interface 54 and the gripper bars 26, the gripper bars 26 may be opened such that sheets 22 which are carried by the respective gripper bars 26 are released from the gripper bars 26 and arranged on or in the hybrid blanking frame 28, for example in a full sheet setup, whereas in a guillotine setup this feature might be not activated, that the “cut-off waste”is transported a bit further in the machine.

The hybrid blanking frame 28 comprises a first linear drive 56 and a second linear drive 58.

As the hybrid blanking frame 28 is shown according to the full-sheet-delivery setup, a front bar 60 is mounted at the front frame portion 42. Moreover, a rear bar 62 is mounted at the movable bar 50 establishing the rear wall portion 48 in this case. In addition, side guides 64, 66 are mounted at mounting arms 67. The mounting arms 67 extend from the front frame portion 42 parallel to the side frame portions 44, 46. Accordingly, the front bar 60, the rear bar 62 and the side guides 64, 66 delimit the interior space 40 of the hybrid blanking frame 28 being prepared according to the full-sheet-delivery setup.

By means of the first linear drive 56 a distance between the opposite side guides 64, 66 may be adjusted. The second linear drive 58 may be used to adjust the distance between the front frame portion 42 and the rear wall portion 48. Accordingly, dimensions of the hybrid blanking frame 28 may be adjusted to the sheets 22 to be handled.

Furthermore, the hybrid blanking frame 28 comprises a lock 68 which may be used to lock the hybrid blanking frame 28 to the sheet processing machine 10. Accordingly, unwanted detachment of the hybrid blanking frame 28 from the sheet processing machine 10 may be prevented.

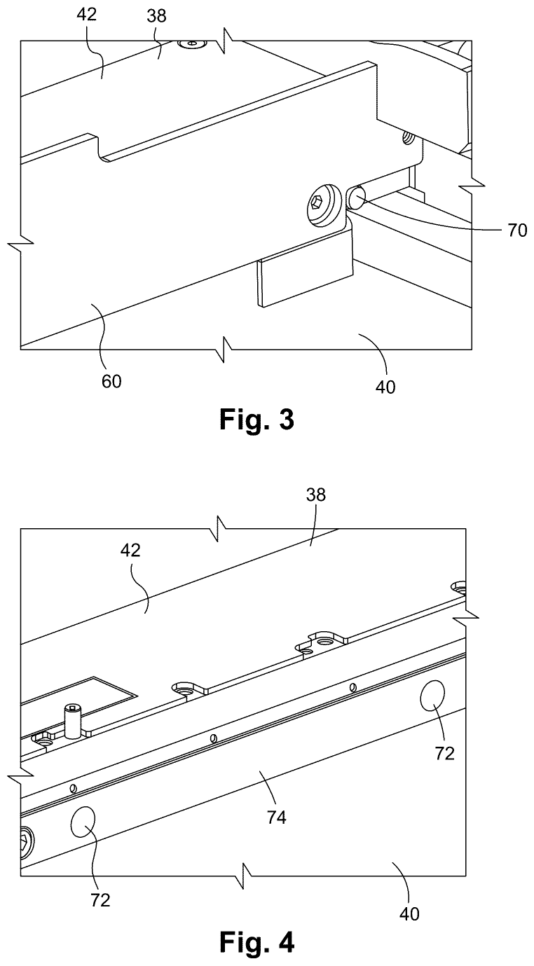

FIG. 3 is a schematic drawing of a front frame portion 42 of the hybrid blanking frame 28 according to an embodiment of the invention.

The hybrid blanking frame 28 comprises according to the shown embodiment several bar guide pins 70 for assisting the mounting procedures of the front bar 60 and the rear bar 62. Here, a portion of the front frame portion 42 of the circumferential frame 38 is shown, where the bar guide pins 70 extend from the front frame portion 42 in a horizontal direction towards the interior space 40 perpendicular to a surface normal of the support surface 52. Similar bar guide pins 70 are established within the movable bar 50 assisting in the mounting procedure of the rear bar 62 to the movable bar 50. With the aid of the bar guide pins 70 appropriate positioning of the front bar 60 and the rear bar 62 is achievable in a convenient fashion.

FIG. 4 is a schematic drawing of magnetic connections 72 provided by the hybrid blanking frame 28 according to an embodiment of the invention. Here, the circumferential frame 38 is shown prior to mounting of the front bar 60. Magnetic connections 72 are provided at an inner surface 74 of the front frame portion 42 delimiting the interior space 40. The front bar 60 comprises a material which may be used with the magnetic connections 72 such that the mounting procedure of the front bar 60 is simplified. As a consequence, a reduced number of screwed connections can be required for mounting the front bar 60 such that the mounting procedure is achievable in shorter time periods.

Similar magnetic connections 72 may optionally also be provided within respective surfaces of the movable bar 50 and/or the mounting arms 67 such that mounting of the rear bar 62 and the side guides 64, 66 is more convenient.

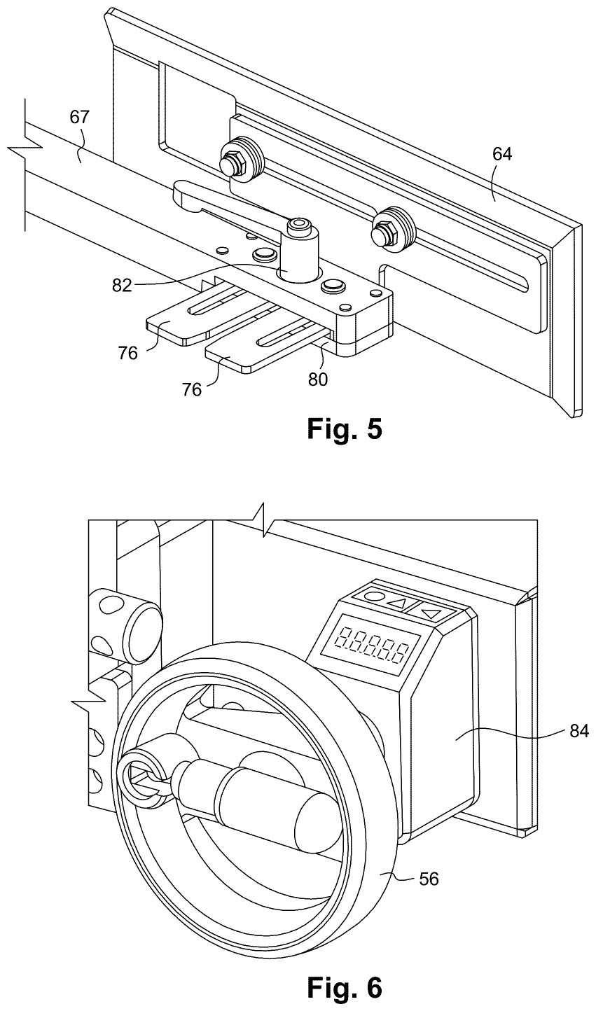

FIG. 5 is a schematic drawing of a side guide 64 used with the full-sheet-delivery setup.

In the present case, the side guide 64 comprises two mounting portions 76. The hybrid blanking frame 28 comprises mounting arms 67 for mounting the respective side guides 64, 66. Each mounting arm 67 has a receiving hole 80 which comprises a shape which is complementary to the combined shape of the mounting portions 76 of the side guides 64, 66. Accordingly, the mounting portions 76 can extend through the receiving hole 80. Moreover, the hybrid blanking frame 28 comprises a compression fitting 82 extending at least partially into the receiving hole 80. With the aid of the compression fitting 82 the mounting portions 76 can be squeezed within the receiving hole 80. Accordingly, the side guide 64 is locked with the mounting arm 67 of the hybrid blanking frame 28. Since the compression fitting 82 is reliably and quickly operable, the mounting procedure of the side guides 64, 66 is very convenient.

FIG. 6 is a schematic drawing of the first linear drive 56 of the hybrid blanking frame 28 according to an embodiment of the invention.

The first linear drive 56 comprises a meter 84 such that the distance between the opposite side guides 64, 66 is continuously adjustable. In this regard, the front frame portion 42 of the circumferential frame 38 comprises a respective thread, along which the mounting arms 67 and, thus, also the side guides 64, 66 may be moved with respect to each other. Therefore, a high precision of the adjusting procedure is guaranteed.

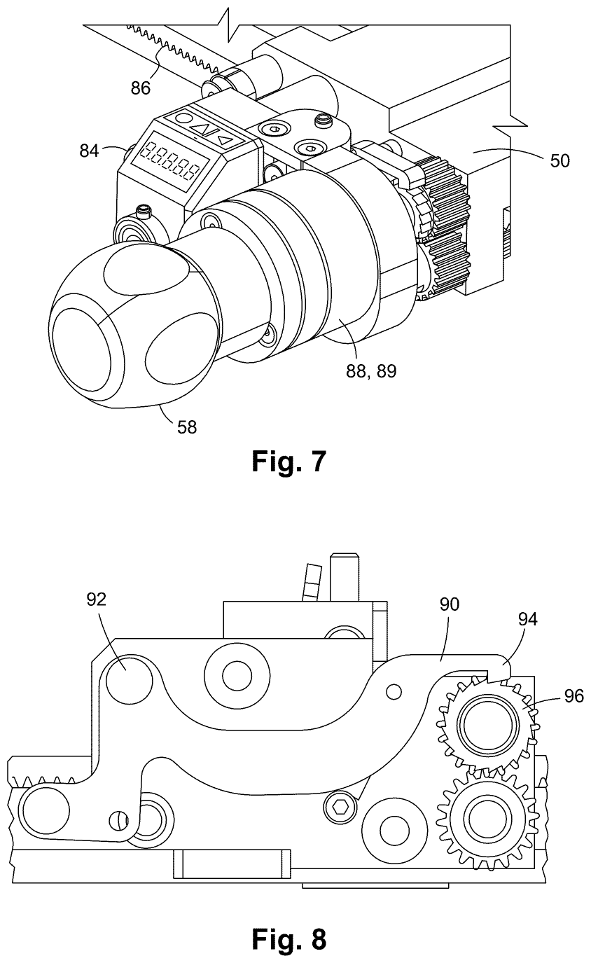

FIG. 7 is a schematic drawing of a second linear drive 58 of the hybrid blanking frame 28 according to an embodiment of the invention. Like the first linear drive 56, the second linear drive 58 also comprises a meter such that the distance between the front frame portion 42 and the movable bar 50 is continuously adjustable. In particular, the movable bar 50 may be driven along threads 86 established within the side frame portions 44, 46 with respect to the front frame portion 42.

Accordingly, by adjusting the positions of the side guides 64, 66 and the movable bar 50 the dimensions of the interior space 40 may be adjusted according to the needs in view of the sheets 22 to be handled.

In addition, according to the present embodiment, the second linear drive 58 comprises a safety clutch 88. FIG. 8 is a schematic drawing of the safety clutch 88 of the second linear drive 58 in more detail. The safety clutch 88 comprises a locking wheel 89 which is coupled to a blocking arm 90 that is rotatable with respect to a support axis 92. A clamping portion 94 of the blocking arm 90 may engage a gearing component 96 such that movement of the gearing component 96 is prevented if the safety clutch 88 is not deactivated. Accordingly, unwanted movement of the movable bar 50 with respect to the front frame portion 42 may be reliably prevented.

Optionally, a safety clutch 88 may be included within the first linear drive 56 as well.

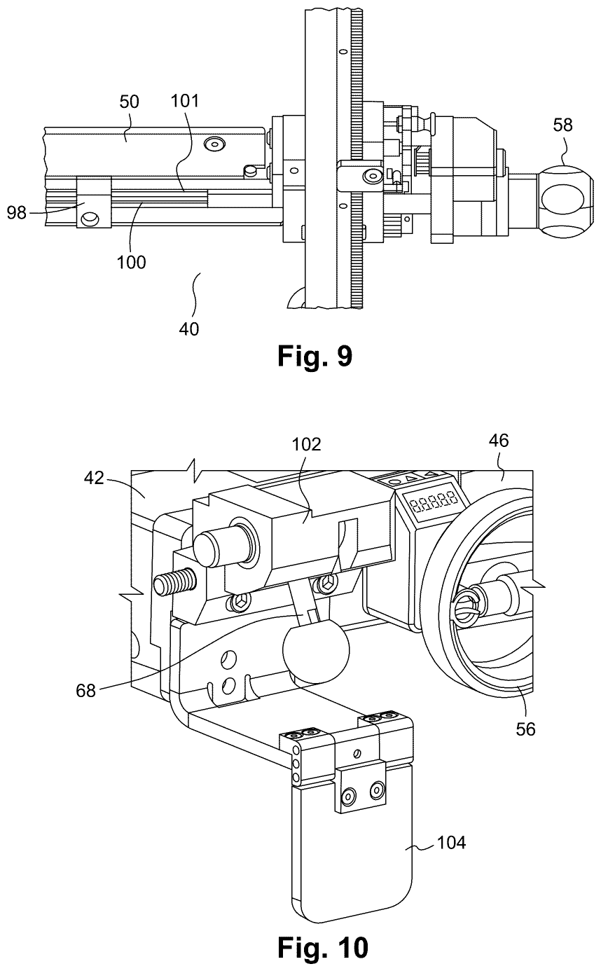

FIG. 9 is a schematic drawing of a support block 98 mounted to the hybrid blanking frame 28 according to an embodiment of the invention. The hybrid blanking frame 28 comprises several screw receptacles for mounting support blocks 98. For example, shown here is a support block 98 (also called jogger bar) mounted to an inner surface 100 of the movable bar 50 delimiting the interior space 40. With the aid of support blocks 98, the support surface 52 may be better defined. Spoken differently, each support block 98 may provide an area of support, for example for a sheet 22, a template bar, or a blanking grid plate, horizontally and vertically. E.g. this could help in a full sheet delivery setup when the support blocks also define the interior space. However, generally support blocks 98 are optional. Basically, if they are required also depends on the component to be mounted and its intrinsic mechanical stability.

The movable bar 50 also comprises a rear slot 101 where clamps may be received which are attached to a blanking grid plate as explained later herein. Similarly, the front frame portion 42 may also comprise a front slot.

FIG. 10 is a schematic drawing of the lock 68 and a movable indicator 104 of the hybrid blanking frame 28 according to an embodiment of the invention. The lock 68 is mounted at a corner 102 of the hybrid blanking frame 28 established between the front frame portion 42 and a side frame portion 46. The lock 68 is configured to establish a mechanic connection with the sheet processing machine 10 if the hybrid blanking frame 28 is mounted thereto.

The movable indicator 104 indicates a present setup of the hybrid blanking frame 28 and is movable such that the lock 68 may optionally not be assessed without removing the indicator 104.

Hence, unwanted removing of the hybrid blanking frame 28 from the sheet processing machine 10 can be prevented since unlocking the lock 68 is required in this regard.

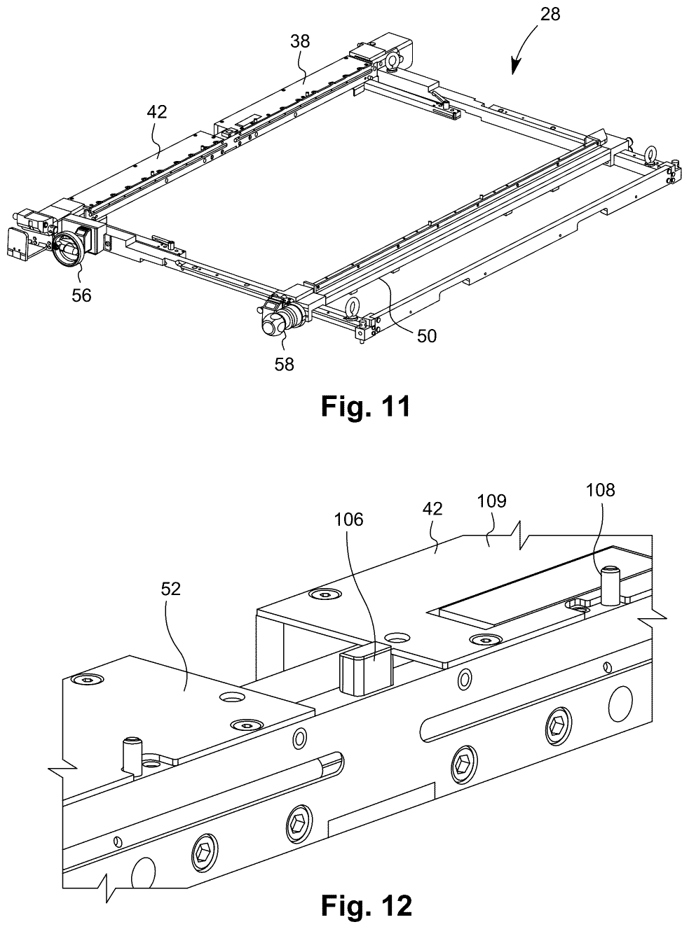

FIG. 11 is a schematic drawing of a hybrid blanking frame 28 according to the quick-lock blanking setup according to an embodiment of the invention.

By removing the front bar 60, the rear bar 62, and the side guides 64, 66 the hybrid blanking frame 28 is prepared according to the quick-lock blanking setup. Depending to the dimensions of the bars and guides it might also be possible to leave them in the hybrid blanking frame. Still, with the aid of the second linear drive 58 a distance between the front frame portion 42 of the circumferential frame 38 and the movable bar 50 may be adjusted according to the needs.

FIG. 12 is a schematic drawing of a front frame portion 42 of the hybrid blanking frame 28 according to an embodiment of the invention.

When being prepared according to the quick-lock blanking setup, the hybrid blanking frame 28 is usually operated in combination with a blanking grid plate. The blanking grid plate is carried by the support surface 52. For appropriately positioning the blanking grid plate the hybrid blanking frame 28 comprises a centering pin 106 and additional plate guide pins 108. The centering pin 106 and the plate guide pins 108 extend perpendicular to a top surface 109 of the front frame portion 42. This means that the centering pin 106 and the plate guide pins 108 are oriented in parallel to a surface normal of the support surface 52.

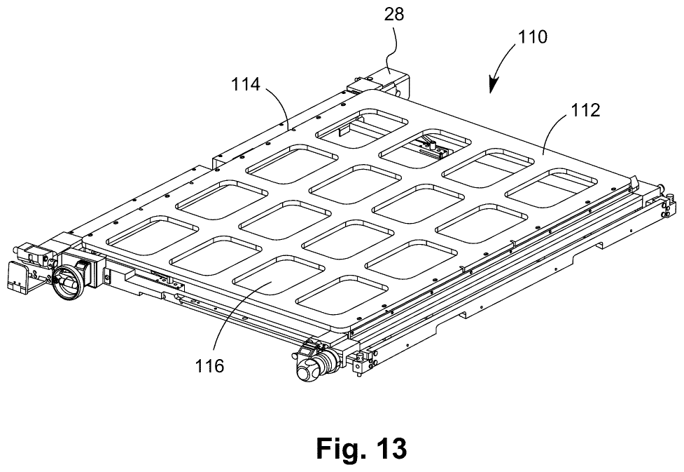

FIG. 13 is a schematic drawing of a blanking system 110 according to an embodiment of the invention. The blanking system 110 comprises a hybrid blanking frame 28 and a blanking grid plate 112.

Generally, the blanking grid plate 112 may be mounted to the blanking grid frame 28 using clamps which are attached to the blanking grid plate 112 itself. The clamps may be received by slots provided by the hybrid blanking frame 28, such as the rear slot 101 shown in FIG. 9.

In addition, the blanking grid plate 112 comprises cut-outs 114 or receptacles which may be aligned with the centering pin 106 and the plate guide pins 108. Accordingly, appropriate alignment of the blanking grid plate 112 with respect to the hybrid blanking frame 28 is guaranteed in a very convenient fashion.

As a consequence of the interaction between the slots of the hybrid blanking frame 28 and the clamps of the blanking grid plate 112 as well as between the cut-outs 114 and the centering pin 106 and the plate guide pins 108, the blanking grid plate 112 may be reliably attached to the hybrid blanking frame 28 omitting any screwed connection. Thus, the hybrid blanking frame 28 is prepared such that mounting of a blanking grid plate 112 is achievable securely and requiring only little time.

Moreover, the blanking grid plate 112 comprises through-holes 116 such that blanks of the sheets 22 may be separated.

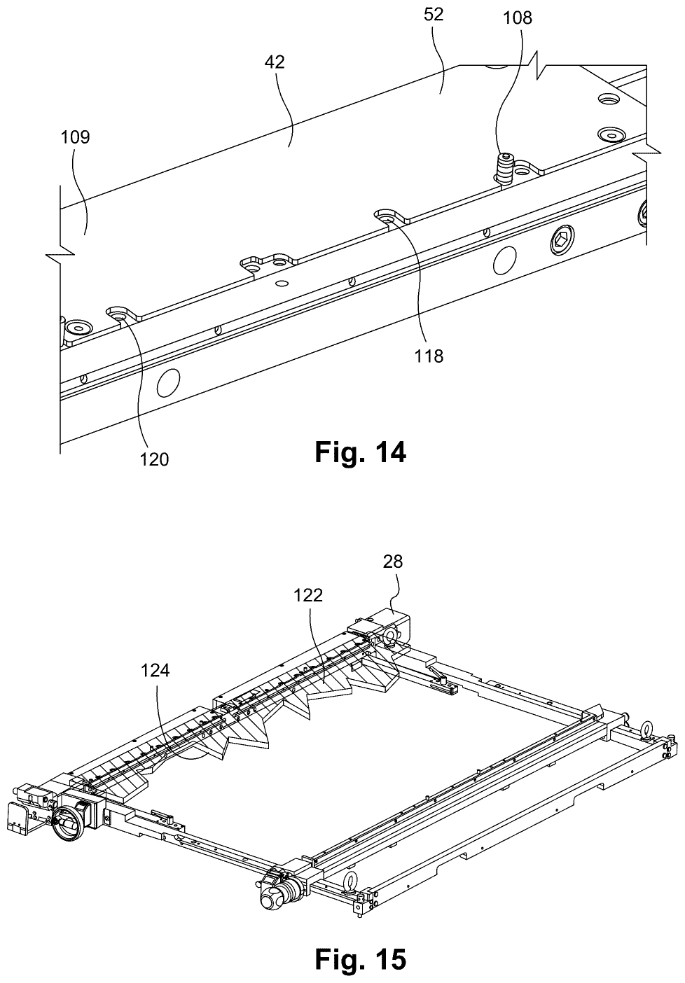

FIG. 14 is a schematic drawing of a front frame portion 42 of the hybrid blanking frame 28 according to an embodiment of the invention.

Within the surface 109 of the front frame portion 42, a screw lock pattern 118 is provided for mounting a template bar used with the hybrid blanking frame 28 when being prepared according to the guillotine setup. This means that within the front frame portion 42 several screw receptacles 120 are provided according to the predefined screw lock pattern 118.

FIG. 15 is a schematic drawing of a hybrid blanking frame 28 according to the guillotine setup according to an embodiment of the invention and a template bar 122.

The template bar 122 is positioned on the support surface 52. For mounting the template bar 122 the screw lock pattern 118 is used. Optionally, the centering pin 106 and/or the plate guide pins 108 may also be used to mount the template bar 122.

The template bar 122 defines a breaking rim 124. With the aid of the template bar 122, a portion corresponding to the breaking rim 124 of one or more sheets 22 arranged on the hybrid blanking frame 28 may be separated from a remainder of the respective sheets 22 using a guillotine device. In this regard, the sheets 22 may be prepared before the separation procedure is carried out. For example, a platen press may be used to perforate the sheets 22 according to the shape of the breaking rim 124.

Therefore, the present hybrid blanking frame 28 is multifunctional and may be used according to different setups. Advantageously, only a single frame is required to provide these different setups. Consequently, the manufacturing expenses of the hybrid blanking frame 28 are reduced as compared to a case where different frames are used for the different setups and the production efficiency of the respective sheet processing machine 10 having the hybrid blanking frame 28 is enhanced.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about”, “approximately”, “near” etc., mean plus or minus 5% of the stated value.

Although the disclosure has been illustrated and described with respect to one or more implementations, equivalent alterations and modifications will occur to others skilled in the art upon the reading and understanding of this specification and the annexed drawings. In addition, while a particular feature of the disclosure may have been disclosed with respect to only one of several implementations, such feature may be combined with one or more other features of the other implementations as may be desired and advantageous for any given or particular application.

1. A hybrid blanking frame for a sheet processing machine, comprising a circumferential frame enclosing an interior space,
wherein a movable bar is mounted between opposite side frame portions of the circumferential frame,
wherein the hybrid blanking frame is configured to support a full-sheet-delivery setup, a guillotine setup, and a quick-lock blanking setup,
wherein the full-sheet-delivery setup comprises a combined first mounting mechanism for mounting a detachable front bar at a front frame portion a detachable rear bar at the movable bar, and detachable side guides parallel to the side frame portions, to receive sheets in the interior space-delimited by the detachable side guides, rear bar and front bar,
wherein the guillotine setup comprises the front frame portion, which is configured to receive a template bar, and at least the template bar and the movable bar establish a support surface to receive sheets, and
wherein for the quick-lock blanking setup at least the front frame portion of the circumferential frame and the movable bar establish a support for a blanking grid plate and wherein the quick-lock setup comprises plate guide pins-extending at least from the front frame portion and the movable bar.

2. The hybrid blanking frame of claim 1, wherein the detachable side guides are configured to engage with mounting arms extending from the front frame portion.

3. The hybrid blanking frame of claim 1, wherein for the quick-lock blanking setup the front bar, the rear bar, and the side guides of the full-sheet-delivery setup are detached.

4. The hybrid blanking frame of claim 1, wherein the front frame bar comprises a screw lock pattern configured to receive a template bar in a guillotine setup.

5. The hybrid blanking frame of claim 1, wherein a first distance between the side guides is adaptable by a first linear drive.

6. The hybrid blanking frame of claim 1, wherein a second distance between the front frame portion and the movable bar is adaptable by a second linear drive.

7. The hybrid blanking frame of claim 1, wherein each linear drive comprises a safety clutch.

8. The hybrid blanking frame of claim 1, wherein the quick-lock blanking setup also comprises at least one centering pin for centering the blanking grid plate.

9. The hybrid blanking frame of claim 1, wherein the front frame portion comprises a front slot and wherein the movable bar comprises a rear slot, the front slot and the rear slot being configured to receive clamps used for mounting the blanking grid plate.

10. The hybrid blanking frame of claim 1, wherein the hybrid blanking frame comprises an interface for a sheet supporting device, and wherein the interface is automatically activated if the front bar is mounted.

11. The hybrid blanking frame of claim 1, wherein the combined first mounting mechanism comprises bar guide pins extending into the interior space of the hybrid blanking frame for supporting at least one of the front bar, the rear bar, and the side guides.

12. The hybrid blanking frame of claim 1, wherein the combined first mounting mechanism comprises magnetic connections for supporting at least one of the front bar, the rear bar, and the side guides.

13. The hybrid blanking frame of claim 2, wherein the combined first mounting mechanism comprises releasable compression fittings for mounting the side guides to the mounting arms.

14. The hybrid blanking frame of claim 1, wherein support blocks and/or support stops are mountable at the detachable front bar and the detachable rear bar for the full-sheet-delivery setup and the guillotine setup.

15. The hybrid blanking frame of claim 1, wherein the hybrid blanking frame comprises a lock for locking the hybrid blanking frame to a sheet processing machine and wherein a movable indicator indicating a present setup of the hybrid blanking frame is configured to cover the lock.

16. A blanking system comprising the hybrid blanking frame according to claim 1 and a blanking grid plate mounted thereto.

17. A sheet processing machine comprising the hybrid blanking frame according to claim 1.
